(19) United States
(12) Patent Application Publication
(10) Pub. No.: US 2021/0017401 A1
(43) Pub. Date: Jan. 21, 2021

(54) ANTIMICROBIAL HEAT SEAL COATING COMPOSITIONS

(71) Applicant: Dow Global Technologies LLC, Midland, MI (US)

(72) Inventor: Thorsten Schmidt, Richterswil (CH)

(21) Appl. No.: 17/043,425

(22) PCT Filed: Jan. 15, 2019
(86) PCT No.: PCT/US2019/013564

§ 371 Date: Sep. 29, 2020

Related U.S. Application Data
(60) Provisional application No. 62/649,810, filed on Mar. 29, 2018.

(51) Int. Cl. C09D 5/14; C09D 133/10; C09J 133/10; C09J 9/00

(52) U.S. Cl. CPC C09D 5/14; C09J 9/00; C09J 133/10; C09D 133/10

(57) ABSTRACT

Antimicrobial heat seal coating compositions are disclosed comprising (A) a copolymer dispersed in a solvent, the copolymer comprising at least one selected from the group consisting of a (meth)acrylate ester (co)polymer, an olefin (co)polymers, a copolymer comprising (meth)acrylic ester units and olefin units and (B) an antimicrobial agent. Food packaging articles are also disclosed, the food packaging articles comprising the disclosed heat seal coatings. When applied in a food packaging application, such as a dairy food packaging application, the disclosed coatings provide for reduced work exposer to hydrogen peroxide and improved packaging reliability.

### FIELD OF THE DISCLOSURE

The instant disclosure relates to antimicrobial heat seal coatings. The disclosed antimicrobial heat seal coatings are particularly useful in food packaging applications, such as dairy food packagings.

In some embodiments, the disclosed heat seal coatings comprise (A) a copolymer dispersed in a solvent, the copolymer comprising at least one selected from the group consisting of a (meth)acrylate ester (co)polymer, an olefin (co)polymer, a copolymer comprising (meth)acrylic ester units and olefin units, and combinations thereof, and (B) an antimicrobial agent. Food packaging articles are also disclosed, the food packaging articles comprising the disclosed heat seal coatings.

When applied in a food packaging application, such as a dairy food packaging application, the disclosed coatings provide for reduced work exposer to hydrogen peroxide and improved packaging reliability.

### BACKGROUND AND SUMMARY OF THE DISCLOSURE

Heat seal coatings are commonly used in food packaging applications. For instance, in dairy food packagings, a lid is often heat sealed to a container using a heat seal coating applied to the lid. The container, which is filled with a foodstuff or drink, is typically made from polypropylene, polystyrene, poly vinyl chloride, or polyethylene terephthalate. The lid is typically a multilayer structure comprising a substrate, usually aluminum foil or polyethylene terephthalate, an ink layer, a protective layer, and a primer layer. The heat seal coating is applied on the substrate and then sealed by application of heat and/or pressure to the container.

Heat seal coatings typically include an organic dispersion of copolymers of (meth)acrylic esters and olefins. These polymers are dissolved in solvents, e.g., a mixture of butyl acetate and methyl ethyl ketone, to form heat seal coatings that require application to the lid with gravure roller, followed by a sufficient drying process. The applied coating weight of such coating varies between 3.5 to 4.5 g/m² (after drying) for dairy product applications, and can reach 6 g/m² when applied to an aluminum substrate. After sealing to the container, the resulting seal strength is typically around 8 N/15 mm.

Heat seal coatings used in dairy packaging applications must demonstrate high resistance to water and fruit acids (e.g., citric, lactic acids). As the lid is fully coated, i.e., not just coated on the perimeter in contact with the container, the heat seal coating is in direct contact with the packed foodstuff or drink. Therefore all coatings have to comply to current food regulations, which are applicable for direct food contact.

The filling of the dairy packagings has to be completed under aseptic conditions. The lid and container materials have to undergo high-concentration hydrogen peroxide treatment in order to avoid cross contamination with bacteria, sperm, and fungus. If aseptic conditions are not met, it will affect the packed dairy product. Besides other treatment possibilities (e.g., UV, steam), hydrogen peroxide is widely used in the dairy product industry, although it requires special and/or expensive safety precautions to protect workers from exposure to hydrogen peroxide.

Accordingly, heat seal coatings for use in food packaging applications that reduce worker exposure to hydrogen peroxide and provide for maintained and/or improved reliability are desirable.

Such heat seal coatings are disclosed herein. In some embodiments, antimicrobial heat seal coatings are disclosed comprising (A) a copolymer dispersed in a solvent, the copolymer comprising at least one selected from the group consisting of a (meth)acrylate ester (co)polymer, an olefin (co)polymer, a copolymer comprising (meth)acrylic ester units and olefin units, and combinations thereof, and (B) an antimicrobial agent.

Food packaging articles are also disclosed, the food packaging articles comprising the disclosed heat seal coatings.

When applied in a food packaging application, such as a dairy food packaging application, the disclosed coatings provide for reduced work exposer to hydrogen peroxide and improved packaging reliability.

### BRIEF DESCRIPTION OF THE DRAWINGS

Reference is made herein to the following Figures, of which:

FIG. 1 shows a graph illustrating survival rate of Escherichia coli after 24 hours of incubation using various Examples.

FIG. 2 shows a graph illustrating survival rate of Listeria monocytogenes after 24 hours of incubation using various Examples.

### DETAILED DESCRIPTION OF THE DISCLOSURE

Antimicrobial heat seal coatings are disclosed comprising (A) a copolymer dispersed in a solvent, the copolymer comprising at least one selected from the group consisting of a (meth)acrylate ester (co)polymer, an olefin (co)polymers, a copolymer comprising (meth)acrylic ester units and olefin units, and combinations thereof, and (B) an antimicrobial agent.

(A) Copolymer Dispersion

In some embodiments, the copolymer dispersed in a solvent comprises at least one selected from the group consisting of a (meth)acrylate ester (co)polymer, an olefin (co)polymers, a copolymer comprising (meth)acrylic ester units and olefin units, and combinations thereof.

The (meth)acrylate ester (co)polymers or (meth)acrylate ester units of the block or graft copolymer comprise (meth)acrylate esters of C1-C20 alkyl alcohols such as for example methyl (meth)acrylate, ethyl (meth)acrylate, propyl (meth)acrylate, n-butyl (meth)acrylate or 2-ethylhexyl (meth)acrylate, and one or more ethylenically unsaturated monomers selected from the group consisting of styrene, alpha-methylstyrene, vinyl chloride, vinyl acetate, vinyl stearate, vinyl methyl ketone, vinyl isobutyl ether, allyl acetate, allyl chloride, allyl isobutyl ether, allyl methyl ketone, dibutyl maleinate, dilauryl maleinate, dibutyl itaconate, vinylpyridine, vinylpyrrolidine, vinylpyrrolidone, vinylcarbazole, vinylimidazole as well as their alkyl derivatives, hydroxy- and dialkylamino alkyl esters of (meth)acrylic and particularly dimethylaminoethyl (meth)acrylate, diethylaminoethyl (meth)acrylate, dimethylamino-propyl (meth)acrylate, hydroxyethyl (meth)acrylate, hydroxy-n-propyl (meth)acrylate or hydroxy-n-butyl (meth)acrylate, nonaromatic hydrocarbons having 2 to 8 carbon atoms and at least 2 olefinic double bonds, e.g. butadiene, isoprene or chloroprene, 2-ethoxyethyl acrylate, 2-butoxyethyl (meth)acrylate, cyclohexyl (meth)acrylate, phenylethyl (meth)acrylate, phenylpropyl (meth)acrylate, (meth)acrylates of heterocyclic alcohols, such as furfuryl (meth)acrylate, (meth)acrylamide and derivatives thereof substituted at the nitrogen by C1-C4-alkyl.

The olefin (co)polymers or olefin units of the block or graft copolymer are composed of ethylene, propylene, butylene and/or other alfa-olefins having from 5 to 20 carbon atoms. Propylene polymers are particularly suited.

In general, copolymer (A) is supplied as dispersion in an organic solvent wherein the solid content, according to ISO 3251, of the dispersion is comprised between 30 and 60 percent, preferably between 40 and 50 percent. Preferably, the solvent is a solvent mixture comprising one or more esters of aliphatic carboxylic acids with aliphatic alcohols and one or more ketones. An aliphatic carboxylic acid that can be used is acetic acid, propionic acid or butyric acid. Aliphatic alcohols that can be used are ethanol, propanol, isopropanol, n-butanol, 2-butanol, 2-methyl-1-propanol or 2-methyl-2-propanol. Examples of ketones that can be used are acetone or methyl ethyl ketone.

In some embodiments, the copolymer dispersed in solvent (A) has a glass transition temperature, as measured by Differential Scanning calorimetry according to ISO 11357-1, of from −60 to −30° C., or from −50 to −40° C.

In some embodiments, the copolymer dispersion (A) accounts for from 90 to 99.9, or from 95 to 99.9, or from 98 to 99.9 percent by weight of the total weight of the antimicrobial heat seal coating composition.

(B) Antimicrobial Agent

In some embodiments, the antimicrobial heat seal coating compositions comprise an antimicrobial agent. In some embodiments, the antimicrobial agent is a substance that has an impact on the growth of bacteria, fungi, and yeast. Suitable antimicrobial agents include, but are not limited to, essential oils, sulfur dioxide, chlorine dioxide, chitosan, silver ions in a zeolite matrix, nisin, sorbic acid, lactic acid, benzoic acid, allyl isothiocyanate, and combinations thereof. In some embodiments, suitable antimicrobial agents can be classified as “natural,” “synthetic,” or “metal-based.” “Natural” refers to a naturally derived substance while “synthetic” refers to a synthetically-formulated substance. The effect principle differentiates between substances which require direct surface contact (e.g. metals) or which emits volatile ingredients into the head space of the packaging.

In some embodiments, the antimicrobial agent (B) accounts for from 0.1 to 10, or from 0.1 to 5, or from 0.1 to 1 percent by weight of the total weight of the antimicrobial heat seal coating composition.

Optional Components

In some embodiments, the disclosed antimicrobial heat seal coating compositions can optionally comprise an antioxidant. For instance, a sterically hindered phenolic antioxidant can be included in the compositions. As indicated in the Examples, inclusion of an antioxidant can further improve the antimicrobial performance of the disclosed compositions.

In some embodiments, the antioxidant accounts for from 0.1 to 1, or from 0.1 to 0.5, or from 0.1 to 0.3 percent by weight of the total weight of the antimicrobial heat seal coating composition.

In some embodiments, the disclosed antimicrobial heat seal coating compositions can optionally comprise a filler. For instance, an inorganic filler such as talc or untreated precipitated silica can be included in the compositions.

In some embodiments, the disclosed antimicrobial heat seal coating compositions can optionally comprise an antiblock agent. Suitable antiblock agents include inorganic materials such as talc or other silica derivatives. Suitable commercially-available antiblock agents include those sold under the ACEMATT™ and AEROSIL™ names by Evonik.

In some embodiments, the disclosed antimicrobial heat seal coating compositions can comprise vinyl chloride vinyl acetate (“VMCH”) copolymer resin when the compositions are used on aluminum foil surfaces. Suitable commercially-available VMCH resins include those sold under the name UCAR™ VMCH by The Dow Chemical Company.

### EXAMPLES OF THE DISCLOSURE

The present disclosure will now be explained in further detail by describing examples illustrating the disclosed adhesive compositions and existing adhesive compositions (Illustrative Examples “IE”, Comparative Examples “CE”, collectively, “the Examples”). However, the scope of the present disclosure is not, of course, limited to the Examples.

Comparative Example 1 (“CE1”) comprises an aluminum foil lid with no heat seal coating applied. Comparative Example 2 (“CE2”) comprises an aluminum foil lid with heat seal coating applied at a coating weight of 4.5 g/m² (dry weight), the heat seal coating comprising DEGALAN™ PM 666, available from Evonik, which is an organic dispersion of methacrylic ester and polyolefin having a solid content of 45 percent, a glass transition temperature of −45° C., and a molecular weight of 300,000 g/mol, in a solvent comprising 70 weight percent butyl acrylate and 30 weight percent methyl ethyl ketone.

Illustrative Example 1 (“IE1”) comprises an aluminum foil lid with heat seal coating applied at a coating weight of 4.5 g/m², the heat seal coating comprising 99 weight percent DEGALAN™ PM 666 in solvent and 1 weight percent Ag+ ion loaded zeolite having a solids content of 100 percent. Illustrative Example 2 (“IE2”) comprises an aluminum foil lid with heat seal coating applied at a coating weight of 4.5 g/m², the heat seal coating comprising 98.8 weight percent DEGALAN™ PM 666 in solvent, 1 weight percent Ag+ ion loaded zeolite having a solids content of 100 percent, and 0.2 weight percent IGRANOX™ 1076 which is a sterically hindered phenolic antioxidant.

The Examples are tested against the following germs: Escherichia coli (gram negative fecal indicator strain), Staphylococcus aures (gram positive skin pathogen), Listeria monocytogenes (gram positive food pathogen), and Candida albicans (yeast). The analysis of antimicrobial effectiveness is performed according to surface contact method ISO/DIS 22196:2006.

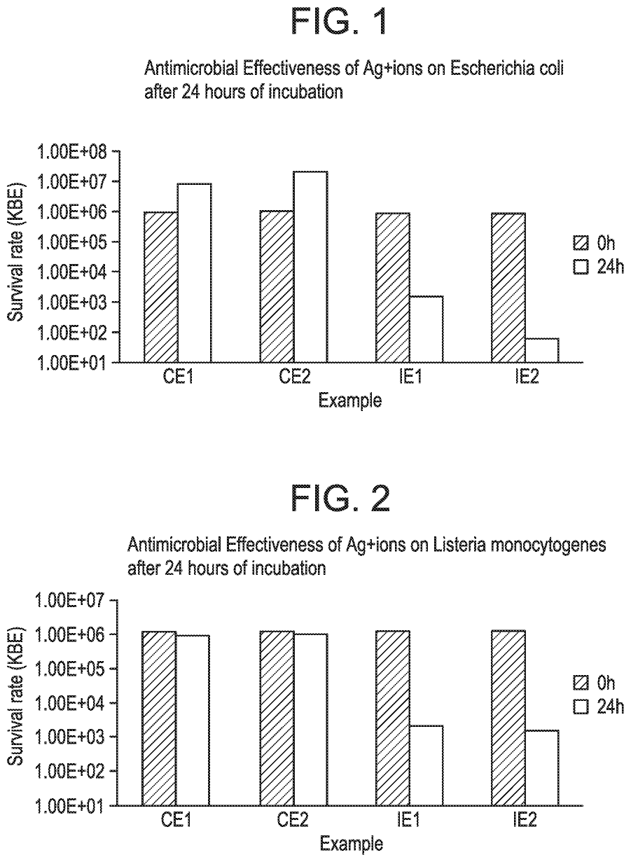

FIG. 1 and FIG. 2 show graphs illustrating the effectiveness of IE1 and IE2 which comprise heat seal coatings with antimicrobial agents (Ag+ ion loaded zeolite) incorporated directly into the heat seal coatings. In particular, IE1 and IE2 showed clear effects against Escherichia coli and Listeria monocytogenes, and lesser but still positive effects against Candida albicans and Staphylococcus aures.

In addition to the embodiments described above, many embodiments of specific combinations are within the scope of the disclosure, some of which are described below:
Embodiment 1. An antimicrobial heat seal coating composition, comprising:
   (A) a copolymer dispersed in a solvent, the copolymer comprising at least one selected from the group consisting of a (meth)acrylate ester (co)polymer, an olefin (co)polymers, a copolymer comprising (meth)acrylic ester units and olefin units; and
   (B) an antimicrobial agent.
Embodiment 2. The antimicrobial heat seal coating composition of any preceding or succeeding Embodiment, wherein the copolymer dispersed in solvent has a glass transition temperature of from −60 to −30° C. as measured by Differential Scanning calorimetry according to ISO 11357-1.
Embodiment 3. The antimicrobial heat seal coating composition of any preceding or succeeding Embodiment, wherein the copolymer dispersed in solvent has a glass transition temperature of from −50 to −40° C. as measured by Differential Scanning calorimetry according to ISO 11357-1.
Embodiment 4. The antimicrobial heat seal coating composition of any preceding or succeeding Embodiment, wherein the solvent is selected from the group consisting of butyl acetate, methyl ethyl ketone, and combinations thereof.
Embodiment 5. The antimicrobial heat seal coating composition of any preceding or succeeding Embodiment, wherein the copolymer dispersed in solvent has a solids content of 45 percent by weight.
Embodiment 6. The antimicrobial heat seal coating composition of any preceding or succeeding Embodiment, wherein the antimicrobial agent is naturally-derived.
Embodiment 7. The antimicrobial heat seal coating composition of any preceding or succeeding Embodiment, wherein the antimicrobial agent is synthetically-derived.
Embodiment 8. The antimicrobial heat seal coating composition of any preceding or succeeding Embodiment, wherein the antimicrobial agent is metal-based.
Embodiment 9. The antimicrobial heat seal coating composition of any preceding or succeeding Embodiment, wherein the antimicrobial agent is a substance having a negative impact on the growth rate of at least one of bacteria, fungi, and yeast.
Embodiment 10. The antimicrobial heat seal coating composition of any preceding or succeeding Embodiment, wherein the antimicrobial agent is selected from the group consisting of essential oil, sulfur dioxide, chlorine dioxide, chitosan, silver-loaded zeolite, nisin, sorbic acid, lactic acid, benzoic acid, allylisothiocyanate, and combinations thereof.
Embodiment 11. The antimicrobial heat seal coating composition of any preceding or succeeding Embodiment, further comprising an antioxidant.
Embodiment 12. The antimicrobial heat seal coating composition of Embodiment 11, wherein the antioxidant is a sterically hindered phenolic antioxidant.
Embodiment 13. The antimicrobial heat seal coating composition of any preceding or succeeding Embodiment, further comprising a filler.
Embodiment 14. The antimicrobial heat seal coating composition of any preceding or succeeding Embodiment, wherein the copolymer dispersion (A) accounts for from 90 to 99.9 percent by weight of the total weight of the composition.
Embodiment 15. The antimicrobial heat seal coating composition of any preceding or succeeding Embodiment, wherein the copolymer dispersion (A) accounts for from 95 to 99.9 percent by weight of the total weight of the composition.
Embodiment 16. The antimicrobial heat seal coating composition of any preceding or succeeding Embodiment, wherein the copolymer dispersion (A) accounts for from 98 to 99.9 percent by weight of the total weight of the composition.
Embodiment 17. The antimicrobial heat seal coating composition of any preceding or succeeding Embodiment, wherein the antimicrobial agent (B) accounts for from 0.1 to 10 percent by weight of the total weight of the composition.
Embodiment 18. The antimicrobial heat seal coating composition of any preceding or succeeding Embodiment, wherein the antimicrobial agent (B) accounts for from 0.1 to 5 percent by weight of the total weight of the composition.
Embodiment 19. The antimicrobial heat seal coating composition of any preceding or succeeding Embodiment, wherein the antimicrobial agent (B) accounts for from 0.1 to 1 percent by weight of the total weight of the composition.
Embodiment 20. An antimicrobial heat seal coating composition, comprising:
   (A) ethylene vinyl acetate dispersed in a solvent; and
   (B) an antimicrobial agent.
Embodiment 21. The antimicrobial heat seal coating composition according to any preceding or succeeding Embodiment, further comprising a vinyl chloride vinyl acetate copolymer resin.
Embodiment 22. A food packaging article, comprising the antimicrobial heat seal coating composition of any preceding or succeeding Embodiment.
Embodiment 23. A food packaging article, comprising:
   a lidding comprising a surface; and
   an antimicrobial heat seal coating uniformly coated on the surface, the coating comprising (A) a copolymer dispersed in a solvent, the copolymer comprising at least one selected from the group consisting of a (meth)acrylate ester (co)polymer, an olefin (co)polymers, a copolymer comprising (meth)acrylic ester units and olefin units and (B) an antimicrobial agent.
Embodiment 24. The food packaging article of Embodiment 23, wherein the lidding comprising a material selected from the group consisting of aluminum foil and polyethylene terephthalate.

That which is claimed is:

1. An antimicrobial heat seal coating composition, comprising:
(A) a copolymer dispersed in a solvent, the copolymer comprising at least one selected from the group consisting of a (meth)acrylate ester (co)polymer, an olefin (co)polymers, a copolymer comprising (meth)acrylic ester units and olefin units; and
(B) an antimicrobial agent.

2. The antimicrobial heat seal coating composition of claim 1, wherein the copolymer dispersed in solvent has a glass transition temperature of from −60 to −30° C. as measured by Differential Scanning calorimetry according to ISO 11357-1.

3. The antimicrobial heat seal coating composition of claim 1, wherein the antimicrobial agent is a substance having a negative impact on the growth rate of at least one of bacteria, fungi, and yeast.

4. The antimicrobial heat seal coating composition of claim 1, wherein the antimicrobial agent is selected from the group consisting of essential oil, sulfur dioxide, chlorine dioxide, chitosan, silver-loaded zeolite, nisin, sorbic acid, lactic acid, benzoic acid, allylisothiocyanate, and combinations thereof.

5. The antimicrobial heat seal coating composition of claim 1, further comprising an antioxidant.

6. The antimicrobial heat seal coating composition of claim 1, further comprising a filler.

7. The antimicrobial heat seal coating composition of claim 1, wherein the copolymer dispersion (A) accounts for from 90 to 99.9 percent by weight of the total weight of the composition.

8. The antimicrobial heat seal coating composition of claim 1, wherein the antimicrobial agent (B) accounts for from 0.1 to 10 percent by weight of the total weight of the composition.

9. An antimicrobial heat seal coating composition, comprising:
(A) ethylene vinyl acetate dispersed in a solvent; and
(B) an antimicrobial agent.

10. A food packaging article comprising the antimicrobial heat seal coating composition of claim 1.
